(19) United States
(12) Patent Application Publication
(10) Pub. No.: US 2014/0365080 A1
(43) Pub. Date: Dec. 11, 2014

(54) DEVICE FOR CONTROLLING OPENING/CLOSING BODY FOR VEHICLE

(71) Applicant: AISIN SEIKI KABUSHIKI KAISHA, Kariya-shi, Aichi-ken (JP)

(72) Inventors: Koichi Hirota, Takahama-shi (JP); Masato Yamada, Hekinan-shi (JP); Takeshi Nishikibe, Tokai-shi (JP); Hitoshi Takayanagi, Kariya-shi (JP)

(21) Appl. No.: 14/374,411

(22) PCT Filed: Feb. 18, 2013
(86) PCT No.: PCT/JP2013/053877

§ 371 Date: Jul. 24, 2014

(30) Foreign Application Priority Data
Feb. 21, 2012 (JP) 2012-035244

(51) Int. Cl. E05F 15/14

(52) U.S. Cl. CPC E05F 15/14
USPC 701/49

(57) ABSTRACT

An opening/closing body control device for a vehicle includes: a drive section for driving the opening/closing body; a manipulation input section operated to open or close the opening/closing body; a manipulation input detector for detecting a manipulation input performed on the manipulation input section; a controller for controlling the drive section; and a measuring section for measuring a duration of the manipulation input. The controller is capable of controlling the drive section in the driving mode selected from a plurality of driving modes to which are set different speeds of actuation of the opening/closing body, and to switch, if the duration exceeds a predetermined time, the driving mode to a high speed actuation mode in which the actuation speed is greater than that in the driving mode before the predetermined time is exceeded.

### TECHNICAL FIELD

The present invention relates to an opening/closing body control device for a vehicle.

### BACKGROUND ART

Opening/closing body control devices for vehicles have been proposed that allow an opening/closing body of a vehicle to be opened and closed by a drive source like a door opening/closing apparatus disclosed in, for example, Patent Document 1. Such a control apparatus detects the manipulation speed of a handle provided on a door and determines the operation speed of the door based on the manipulation speed.

That is, there is a correlation between the manipulation speed of the door handle and the operation speed of the door that the user desires. With the above configuration, the operation speed of the opening/closing body is easily changed by intuitive manipulation input to the door handle by the user. This improves convenience for users.

### PRIOR ART DOCUMENTS

### Patent Document

Patent Document 1: Japanese Patent No. 4161898

### SUMMARY OF THE INVENTION

### Problems that the Invention is to Solve

However, in a manipulation member such as a door handle, since the manipulation force required to manipulate the manipulation member at the same manipulation speed typically changes due to deterioration with age, there is a possibility that the manipulation speed of the manipulation member may not always reflect the intention of a user. In particular, in an opening/closing body such as a door in which the operation position is restrained at the fully closed position (or the fully opened position) by a lock mechanism, strong manipulation force is required for manipulating the manipulation member to release the lock mechanism. It is therefore difficult to intentionally adjust the manipulation speed of the manipulation member. In addition, the configuration for detecting the manipulation speed of the manipulation member increases manufacturing costs.

Accordingly, it is an objective of the present invention to provide an opening/closing body control device for a vehicle that allows a user to operate an opening/closing body at a desired appropriate speed.

### Means for Solving the Problems

To achieve the foregoing objective, the present invention provides an opening/closing body control device for a vehicle that includes a drive section, a manipulatin input section, a manipulation input detector, a controller, and a measuring section. The drive section drives an opening/closing body of the vehicle. The manipulation input section is manipulated to open and close the opening/closing body. The manipulation input detector detects a manipulation input to the manipulation input section. The controller controls the drive section based on detection of the manipulation input. The measuring section measures a duration of the manipulation input. The controller is configured to be capable of controlling the drive section in a drive mode selected from a plurality of drive modes which have different operation speeds of the opening/closing body. The controller is also configured such that, when the duration exceeds a predetermined time period, the controller switches the drive mode to a high-speed operation mode the operation speed of which is greater than the drive mode selected before the duration exceeds the predetermined time period.

Most users tend to easily accept that “there is a correlation between the duration of manipulation input to the manipulation input section and the operation speed of the opening/closing body” in a sensory way from, for example, past experience. Measuring the duration of the manipulation input is advantageous because it is unlikely to be affected by the type and structure of the manipulation input section, which is the manipulation input section, and deterioration with age. With the above configuration, the opening/closing body is opened and closed at an appropriate speed that the user desires by intuitive manipulation. As a result, the operability and convenience are improved.

### BRIEF DESCRIPTION OF THE DRAWINGS

FIG. 1 is a schematic diagram illustrating a door control device according to the present invention;

FIG. 2 is a flowchart showing the manner of a door opening/closing control;

FIG. 3 is a flowchart showing the procedure of an operation speed varying control according to a first embodiment, and in particular showing the procedure of mode shift determination based on the duration of manipulation input to the door handle;

FIG. 4 is a flowchart showing the procedure of the operation speed varying control according to the first embodiment, and in particular showing the procedure of mode shift determination and switching of drive modes based on stopping of the operation of the sliding door;

FIG. 5 is an explanatory diagram showing deceleration zones set corresponding to the fully closed position and the fully open position of the sliding door;

FIG. 6 is a flowchart showing the procedure of the operation speed varying control according to the first embodiment, and in particular showing the procedure of mode shift determination based on entry to the deceleration zones;

FIG. 7 is an explanatory diagram showing operation of the operation speed varying control according to the first embodiment;

FIG. 8 is a flowchart showing the procedure of an operation speed varying control according to a second embodiment, and in particular showing the procedure of mode shift determination based on stopping of manipulation input to the door handle;

FIG. 9 is an explanatory diagram showing operation of the operation speed varying control according to the second embodiment;

FIG. 10 is a schematic diagram illustrating a door handle including a push switch and a contact switch; and

FIG. 11 is a schematic diagram illustrating a door handle operable by manipulation inputs in two directions.

### MODES FOR CARRYING OUT THE INVENTION

### First Embodiment

A first embodiment of the present invention will now be described with reference to the drawings.

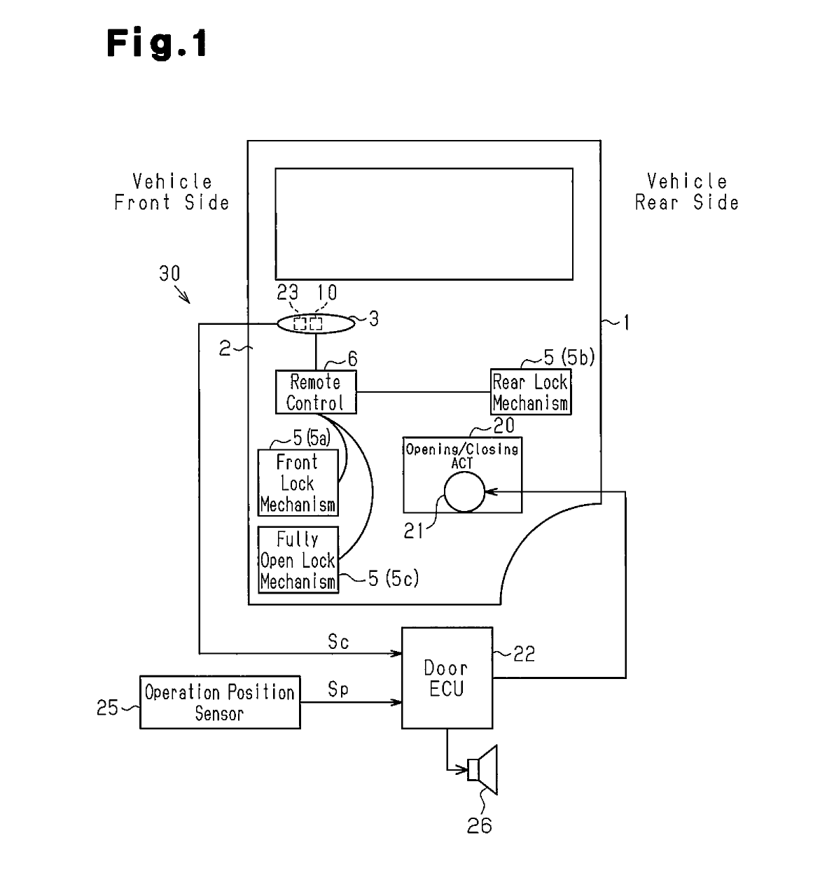

As shown in FIG. 1, an opening/closing body, which is a sliding door 1 in this embodiment, is movable in a vehicle fore-and-aft direction to be able to open/close an opening portion (not shown) formed in a side surface of a vehicle body. More specifically, the sliding door 1 moves toward a vehicle front side (left side in FIG. 1) to be held in a closed state where the sliding door 1 closes the opening portion of the body, and moves toward a vehicle rear side (right side in FIG. 1) to be held in an open state where passengers are allowed to get in and out through the opening portion. An outer panel 2, which forms the outer surface (ornamental surface) of the sliding door 1, is provided with a handle unit, which is a door handle 3 in this embodiment. The door handle 3 is manipulated to open and close the sliding door 1.

The sliding door 1 is provided with a front lock mechanism 5a, which restrains the sliding door 1 at a fully closed position, and a rear lock mechanism 5b. The front lock mechanism 5a and the rear lock mechanism 5b form a fully closed lock mechanism. Furthermore, the sliding door 1 is provided with a fully open lock mechanism 5c, which restrain the sliding door 1 at the fully open position. The lock mechanisms (in other words, latch mechanisms) 5 are mechanically connected to the door handle 3 via a transmission member such as a wire that extends from a remote control 6.

A movable handgrip 10 is provided on the door handle 3, which functions as a manipulation input section, and manipulation force based on manipulation input to the door handle 3 is transmitted to the lock mechanisms 5 from the handgrip 10. The handgrip 10 has a known configuration in which, when the handgrip 10 is manipulated toward the vehicle rear side, which is the opening direction of the sliding door 1, the distal end (end toward a vehicle front side) of the handgrip 10 is pulled. Upon receipt of the manipulation force, each of the lock mechanisms 5 releases restraint of the sliding door 1 to permit the sliding door 1 at the fully closed position to move in the opening direction, or the sliding door 1 at the fully open position to move in a closing direction.

The sliding door 1 includes a drive section, which is capable of opening and closing the sliding door 1. The drive section is a door opening/closing actuator (opening/closing ACT) 20 in this embodiment. The door opening/closing actuator 20 is configured to open and close the sliding door 1, which is an object driven by the door opening/closing actuator 20, when a controller, which is a door ECU 22 in this embodiment, supplies driving electricity to a motor 21, which is a drive source of the door opening/closing actuator 20.

A contact-type manipulation detecting switch 23, which operates in response to the motion of the handgrip 10, is provided on the door handle 3. Based on a manipulation input signal Sc output from the manipulation detecting switch 23, the door ECU 22 detects a manipulation input (presence/absence of a manipulation input) to the door handle 3. An operation position sensor 25 is connected to the door ECU 22. The door ECU 22 detects the operation position (opening/closing position) of the sliding door 1 based on a signal (operation position signal Sp) output from the operation position sensor 25. The door ECU 22 controls operation of the door opening/closing actuator 20 to open or close (or stop) the sliding door 1 in accordance with the manipulation input to the door handle 3 and the detected operation position of the sliding door 1.

In the present embodiment, the manipulation detecting switch 23 and the door ECU 22 configure a manipulation input detector. Furthermore, the operation position sensor 25 and the door ECU 22 configure an operation position detector. The above-mentioned drive section (20), the controller (22), the manipulation input section (3), the manipulation input detector (22, 23) and the operation position detector (22, 25) configure the opening/closing body control device for a vehicle, which is a door control device 30.

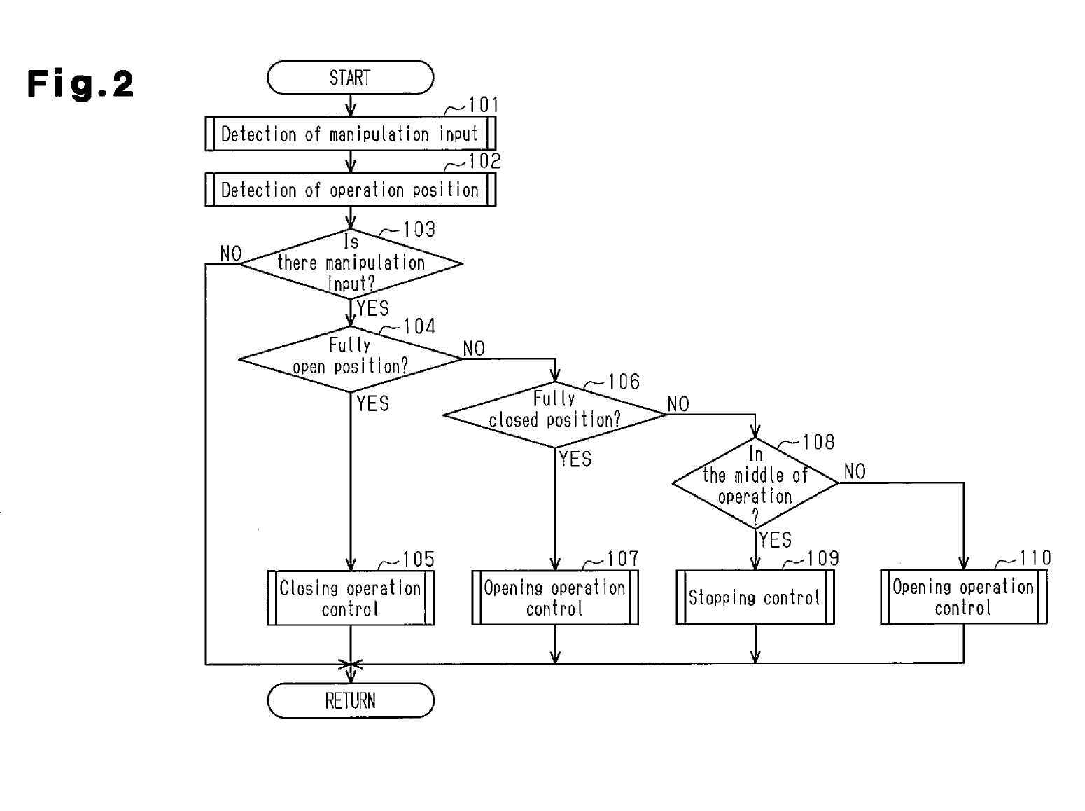

The manner and procedure of a door opening/closing control according to the present embodiment will now be described. The door ECU 22 periodically executes the computation process shown in the flowchart of FIG. 2.

As shown in the flowchart of FIG. 2, the door ECU 22 first executes a manipulation input detecting procedure (step 101) based on the manipulation input signal Sc and an operation position detecting procedure (step 102) based on the operation position signal Sp. The door ECU 22 then determines whether there is a manipulation input to the door handle 3 (step 103). If it is determined that there is a manipulation input, that is, if a manipulation input is detected (step 103: YES), the door ECU 22 subsequently determines whether the sliding door 1 is at the fully open position (step 104). If it is determined that the sliding door 1 is at the fully open position (step 104: YES), the door ECU 22 executes a closing operation control to close the sliding door 1 (step 105) by the door opening/closing actuator 20.

If it is determined, in step 103, that there is no manipulation input to the door handle 3 (a manipulation input is not detected) (step 103: NO), the door ECU 22 does not execute the processes of step 104 and the subsequent steps.

If it is determined, in step 104, that the sliding door 1 is not at the fully open position (step 104: NO), the door ECU 22 subsequently determines whether the sliding door 1 is at the fully closed position (step 106). If it is determined that the sliding door 1 is at the fully closed position (step 106: YES), the door ECU 22 executes an opening operation control to open the sliding door 1 (step 107) by the door opening/closing actuator 20.

Furthermore, if it is determined, in step 106, that the sliding door 1 is not at the fully closed position (step 106: NO), that is, if the sliding door 1 is located at a position moved from the fully closed position, the door ECU 22 subsequently determines whether the sliding door 1 is in the middle of operation (step 108). If it is determined that the sliding door 1 is in the middle of operation, that is, if it is determined that the closing operation control or the opening operation control is being executed (step 108: YES), the door ECU 22 executes a stopping control to stop the operation of the sliding door 1 (step 109).

If it is determined, in step 108, that the sliding door 1 is not in the middle of operation, that is, if it is determined that the sliding door 1 has already been stopped (step 108: NO), the door ECU 22 executes the opening operation control to open the sliding door 1 by the door opening/closing actuator 20 (step 110).

The door control device 30 of the present embodiment, which executes the procedure as described above, reduces the burden on users by opening or closing the sliding door 1 in accordance with the situation in which the door handle 3 is manipulated.

(Operation Speed Varying Control)

The manner of the operation speed varying control according to the present embodiment will now be described.

The door ECU 22 of the present embodiment has a function to control the door opening/closing actuator 20 (see FIG. 1) in a drive mode selected from drive modes with the operation speed of the sliding door 1 set to different speeds. More specifically, the door ECU 22 includes a basic drive mode, which is a normal mode, and a high-speed operation mode as the drive modes. The operation speed of the sliding door 1 in the high-speed operation mode is greater than that in the normal mode. The opening/closing control (opening operation control or closing operation control) of the sliding door 1 is started in the normal mode among the two drive modes.

The door ECU 22 of the present embodiment also measures duration (t) of the manipulation input to the door handle 3 based on the manipulation input signal Sc output from the manipulation detecting switch 23 provided in the door handle 3. More specifically, the door ECU 22, which functions as a measuring section, measures, as the duration (t) of the manipulation input, the time period from the point in time when the user manipulates the door handle 3 in such a manner as to pull the handgrip 10 to the point in time when the user lets go of the handgrip 10. If the duration (t) of the manipulation input exceeds a predetermined time period (t0), the door ECU 22 switches the drive mode from the normal mode, which is selected at the starting of the opening/closing control, to the high-speed operation mode.

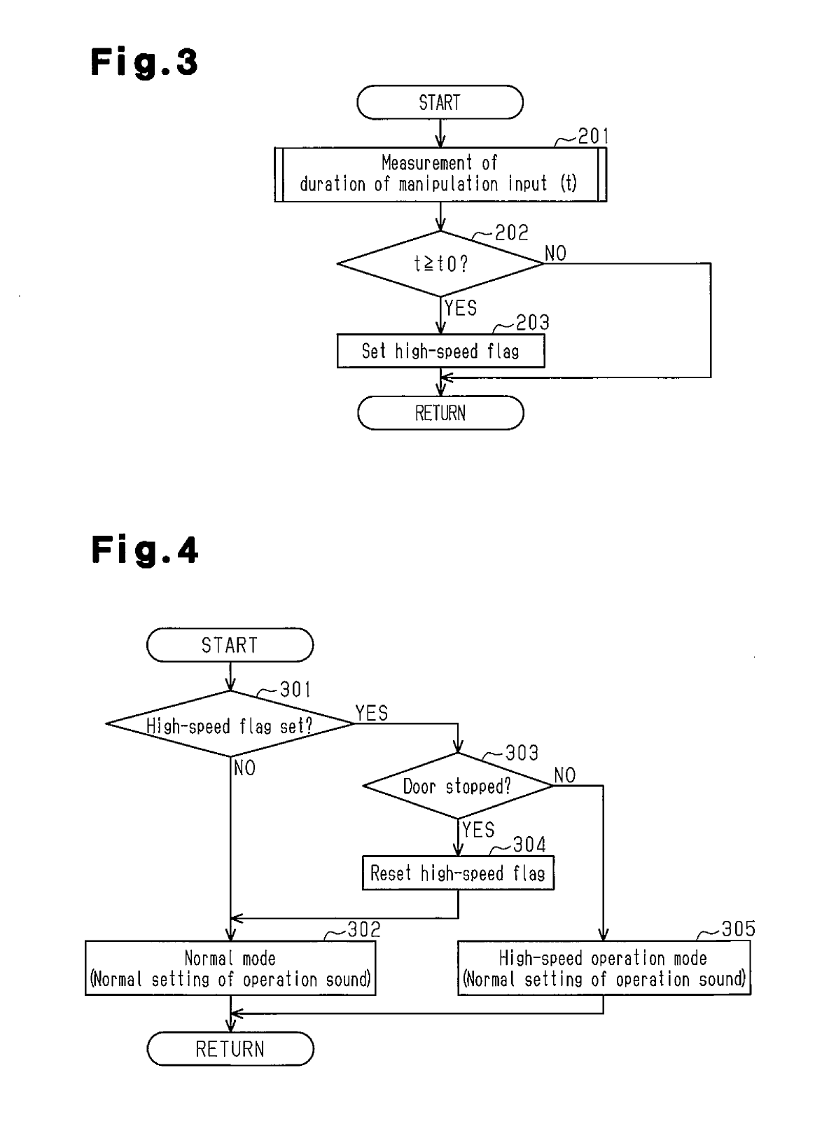

Specifically, as shown in the flowchart of FIG. 3, when the measuring process of the duration of the manipulation input is executed (step 201), the door ECU 22 determines whether the duration t exceeds the predetermined time period t0 (step 202). If the duration t of the manipulation input exceeds the predetermined time period t0 (t to, step 200: YES), the door ECU 22 sets a high-speed flag to switch the drive mode to the high-speed operation mode (step 203).

The door ECU 22 of the present embodiment executes the processes of step 201 to step 203 as a subroutine of the manipulation input detecting procedure (see FIG. 2, step 101). When the high-speed flag is set in step 203, the drive mode is switched from the normal mode to the high-speed operation mode in the closing operation control (see FIG. 2, such as step 105) or the opening operation control (see FIG. 2, steps 107 and 110) that is under execution.

In step 202, if the duration t of the manipulation input is less than the predetermined time period t0 (t<t0, step 202: NO), the process of step 203 is not executed. In this case, since the closing operation control or the opening operation control is executed without setting the high-speed flag, the drive mode is maintained in the normal mode.

More specifically, as shown in the flowchart of FIG. 4, the door ECU 22 first determines whether the high-speed flag is set when executing the opening/closing control (step 301). If the high-speed flag is not set (step 301: NO), the door ECU 22 executes the opening/closing control in the normal mode (step 302).

If it is determined, in step 301, that the high-speed flag is set (step 301: YES), the door ECU 22 subsequently determines whether the sliding door 1 is in a stopped state (step 303). If the sliding door 1 is in a stopped state (step 303: YES), the door ECU 22 resets the high-speed flag (step 304), and executes the opening/closing control in the normal mode (step 302).

That is, in the present embodiment, in a state where the sliding door 1 is in a stopped state, the high-speed flag is reset and the drive mode is switched to the normal mode regardless of the operation position of the sliding door 1. The opening/closing control of the sliding door 1 is thus always started in the normal mode.

If it is determined, in step 303, that the sliding door 1 is not in a stopped state, that is, the sliding door 1 is in the middle of operation (step 303: NO), the door ECU 22 executes the opening/closing control in the high-speed operation mode (step 305).

The door control device 30 of the present embodiment has a function that outputs, while the sliding door 1 is in the opening/closing operation, a pulse sound the time interval of which changes in accordance with the operation speed of the sliding door 1 via a notification device, which is a speaker 26 in this embodiment (see FIG. 1), as an operation sound that indicates that the sliding door 1 is in operation. More specifically, the door ECU 22, which configures a notification section with the speaker 26, widens the time interval of the pulse sound in the normal mode (step 302), and narrows the time interval of the pulse sound in the high-speed operation mode (step 305). The change in the time interval of the pulse sound notifies the user of the currently executed drive mode.

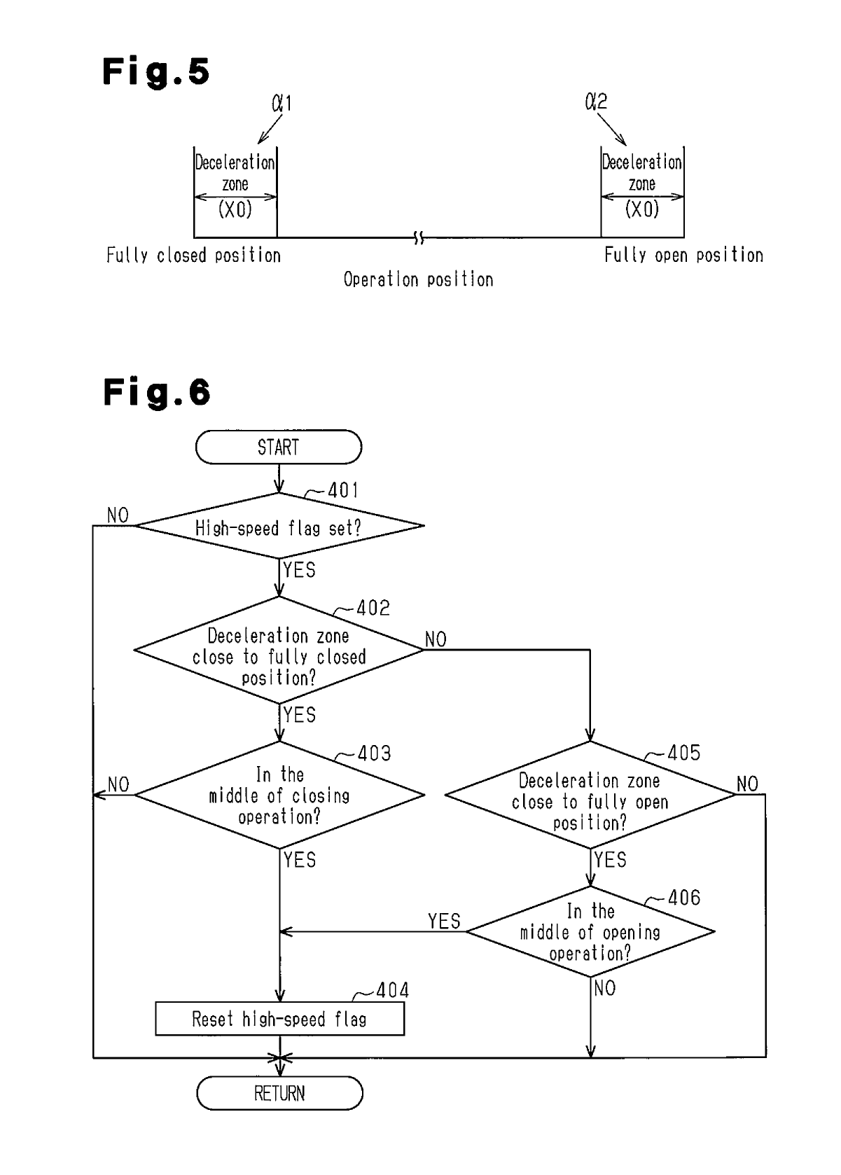

As shown in FIG. 5, deceleration zones α1, α2 are set in the vicinity of the fully open position and the fully closed position of the sliding door 1 in the present embodiment. The deceleration zones α1, α2 are each set as a range where the remaining distance (X) by which the sliding door 1 reaches the fully closed position or the fully open position is less than or equal to a predetermined value X0. That is, the deceleration zones α1, α2 are zones between the fully closed position or the fully open position of the sliding door 1 and a position separated therefrom by the predetermined value X0. The door ECU 22 of the present embodiment is configured such that, if the drive mode is the high-speed operation mode at the time when the sliding door 1 enters the deceleration zones α1, α2, the door ECU 22 switches the drive mode from the high-speed operation mode to the normal mode.

More specifically, as shown in the flowchart of FIG. 6, the door ECU 22 determines whether the high-speed flag is set (step 401). If the high-speed flag is set (step 401: YES), the door ECU 22 first determines whether the operation position of the sliding door 1 is in the deceleration zone α1 close to the fully closed position (step 402). If it is determined, in step 402, that the operation position of the sliding door 1 is in the deceleration zone α1 close to the fully closed position (step 402: YES), the door ECU 22 subsequently determines whether the sliding door 1 is in the middle of closing operation (step 403). If it is determined that the sliding door 1 is in the middle of closing operation, that is, if the sliding door 1 enters the deceleration zone al close to the fully closed position (step 403: YES), the door ECU 22 resets the high-speed flag (step 404).

If it is determined, in step 402, that the operation position of the sliding door 1 is not in the deceleration zone al close to the fully closed position (step 402: NO), the door ECU 22 determines whether the operation position of the sliding door 1 is in the deceleration zone α2 close to the fully open position (step 405). If it is determined, in step 405, that the operation position of the sliding door 1 is in the deceleration zone α2 close to the fully open position (step 405: YES), the door ECU 22 subsequently determines whether the sliding door 1 is in the middle of opening operation (step 406). If it is determined that the sliding door 1 is in the middle of opening operation, that is, if the sliding door 1 enters the deceleration zone α2 close to the fully open position (step 406: YES), the door ECU 22 resets the high-speed flag in step 404.

If it is determined, in step 403, that the sliding door 1 is not in the middle of closing operation (step 403: NO), or if it is determined, in step 406, that the sliding door 1 is not in the middle of opening operation (step 406: NO), the door ECU 22 does not execute the process in step 404. Furthermore, if it is determined, in step 405, that the operation position of the sliding door 1 is not in the deceleration zone α2 close to the fully open position, that is, not in either deceleration zones α1, α2 (step 405: NO), the door ECU 22 does not execute the processes in steps 404, 406. If it is determined, in step 401, that the high-speed flag is not set (step 401: NO), the door ECU 22 does not execute the processes of step 402 and the subsequent steps.

The door ECU 22 executes the processes of step 401 to step 406 as a subroutine of the operation position detecting procedure (see FIG. 2, step 102). When the high-speed flag is reset in step 404, the drive mode is switched from the high-speed operation mode to the normal mode in the closing operation control (see FIG. 2, such as step 105) or the opening operation control (see FIG. 2, such as step 107 and step 110) that is under execution. Thus, the sliding door 1 that has entered the deceleration zones α1, α2 in the high-speed operation mode decelerates.

Operation of the door control device according to the present embodiment configured as described above will now be described.

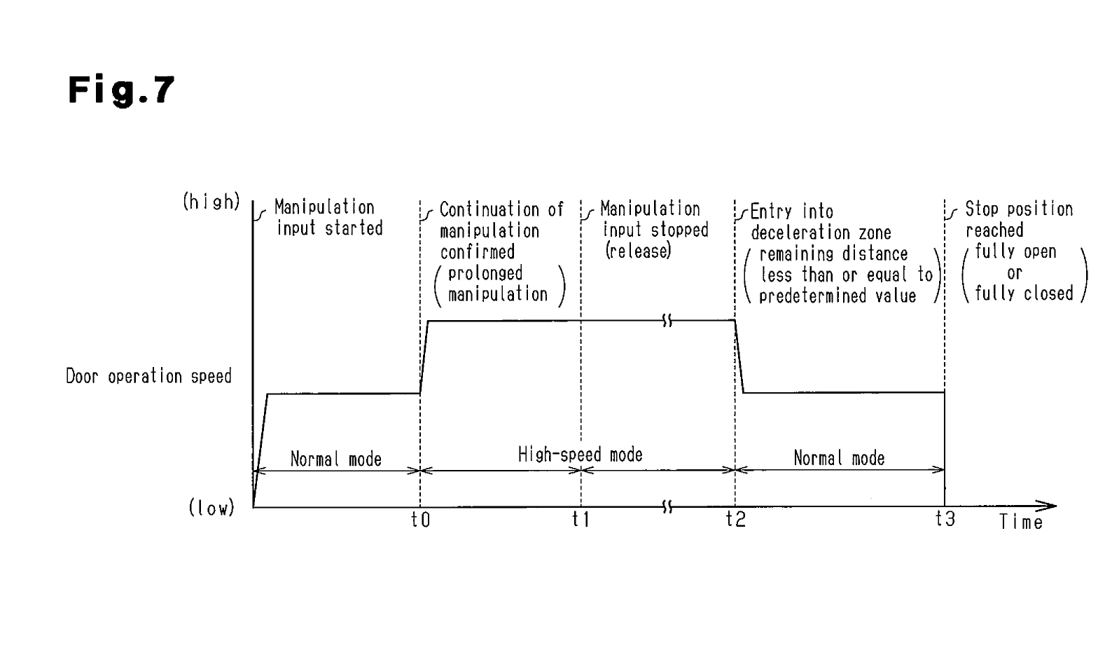

As shown in FIG. 7, upon detection of the manipulation input to the door handle 3, the opening/closing control of the sliding door 1 is started in the normal mode. In the present embodiment, if the manipulation input is continued thereafter, that is, if the user performs “prolonged manipulation,” where the user keeps manipulating the door handle 3 (specifically, the handgrip 10), the duration t of the prolonged manipulation is measured. If it is determined that the prolonged manipulation is continued over the predetermined time period t0, the drive mode is switched to the high-speed operation mode, and the operation speed of the sliding door 1 is increased.

In the present embodiment, after the duration t of the prolonged manipulation exceeds the predetermined time period t0, if the manipulation input is stopped (point in time t1), that is, if the user lets go of the door handle 3 (more specifically, the handgrip 10), the high-speed operation mode is maintained thereafter.

Subsequently, if the sliding door 1 enters the deceleration zone, the drive mode is switched from the high-speed operation mode to the normal mode, and the operation speed of the sliding door 1 decelerates (point in time t2). While continuing to be decelerated, the sliding door 1 reaches the stop position, which is the fully closed position or the fully open position (point in time t3).

The present embodiment has the following advantages.

(1) The door ECU 22 measures the duration t of the manipulation input to the door handle 3 (step 201) and if the duration t exceeds the predetermined time period t0 (t t0, step 202: YES), the door ECU 22 sets the high-speed flag to switch the drive mode from the normal mode to the high-speed operation mode (step 203).

That is, most of the users tend to easily accept that “there is correlation between the duration of the manipulation input and increase in the operation speed” in a sensory way from, for example, past experience. Measuring the duration of the manipulation input is advantageous because it is unlikely to be affected by the type and structure of the door handle 3, which is the manipulation input section, and deterioration with age. With the above configuration, the sliding door 1 is more reliably opened and closed at an appropriate speed that the user desires by intuitive manipulation. As a result, the operability and convenience are further improved.

(2) The door handle 3 includes the movable handgrip 10. The door ECU 22 detects manipulation to move the handgrip 10, that is, manipulation that pulls the handgrip 10 as the manipulation input, and executes switching of the drive mode based on the duration (t) of the manipulation input.

According to the above configuration, the operation speed of the sliding door 1 is switched by a method that is easy to continuously manipulate and is easy to intuitively understand. As a result, the operability and convenience are improved. Since the operation speed varying control of the sliding door 1 is performed by only utilizing the existing configuration without adding a new component, the manufacturing costs are prevented from increasing.

(3) The door ECU 22 maintains the high-speed operation mode even if the manipulation input is stopped after switching the drive mode to the high-speed operation mode. Thus, the operation speed is kept great even after the user lets go of the door handle 3. This allows the user to save the trouble of having to continue pulling the handgrip 10 and increases the convenience.

(4) If the drive mode when the sliding door 1 is stopped is the high-speed operation mode, the door ECU 22 restores the drive mode to the normal mode. With this configuration, the opening operation control or the closing operation control is prevented from being started with a great operation speed of the sliding door 1. As a result, the sliding door 1 is opened or closed at an appropriate speed that the user desires. Furthermore, a high level of safety is also ensured.

(5) The deceleration zones α1, α2 are set in the vicinity of the fully open position and the fully closed position of the sliding door 1. If the drive mode is the high-speed operation mode at the time when the sliding door 1 enters the deceleration zones α1, α2, the door ECU 22 switches the drive mode from the high-speed operation mode to the normal mode.

With the above configuration, since the sliding door 1 decelerates before reaching the stop position, which is the fully open position or the fully closed position, the sensation associated with the operation of the sliding door 1 is improved. In particular, when fully closing the sliding door 1, load applied to a foreign object that might get caught between the sliding door 1 and the vehicle body is reduced.

(6) The door control device 30 has a function that outputs a pulse sound when the sliding door 1 is in opening/closing operation as an operation sound for indicating that the sliding door 1 is in operation. The time intervals of the pulse sound change in accordance with the operation speed.

With the above configuration, the user is notified of the drive mode that is under execution. Thus, the user is informed and warned of, for example, the fact that the operation speed of the sliding door 1 is accelerated.

### Second Embodiment

A second embodiment of the present invention will now be described with reference to the drawings. Like or the same reference numerals are given to those components that are like or the same as the corresponding components of the first embodiment and detailed explanations are omitted.

In the present embodiment, after switching the drive mode from the normal mode to the high-speed operation mode, the door ECU 22 restores the drive mode to the normal mode if the manipulation input to the door handle 3 is stopped.

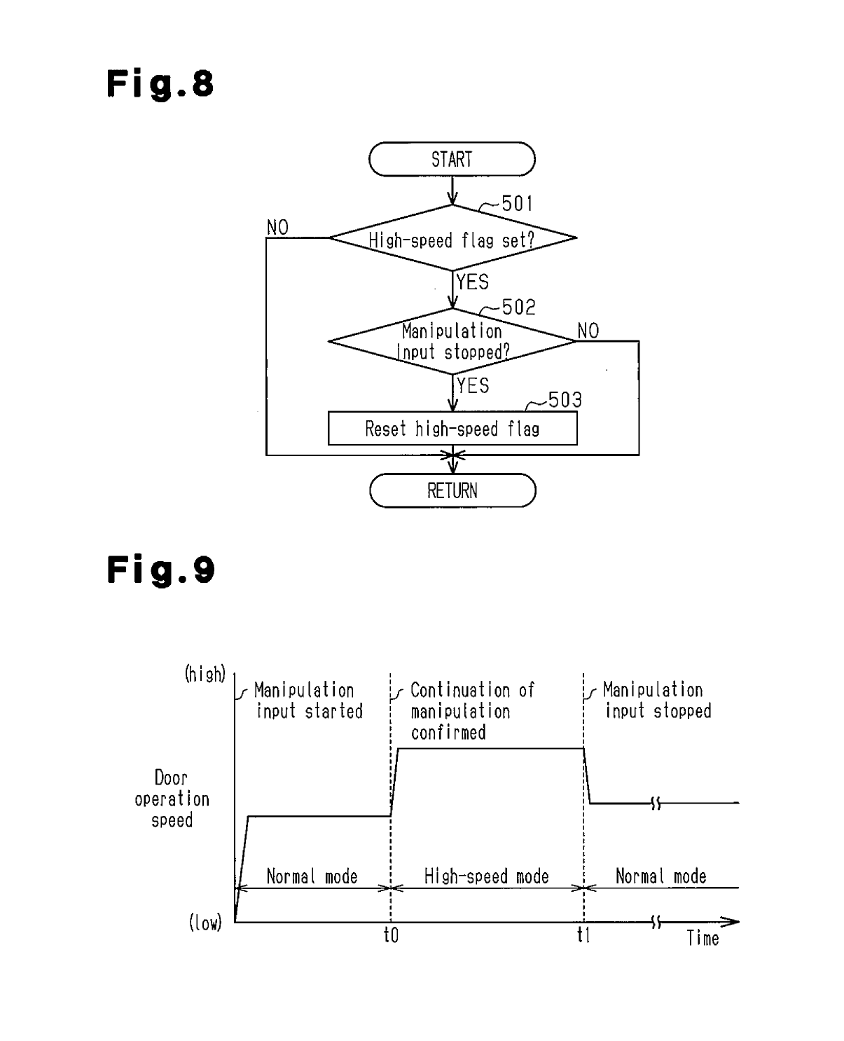

More specifically, as shown in the flowchart of FIG. 8, the door ECU 22 determines whether the high-speed flag is set (step 501). If the high-speed flag is set (step 501: YES), the door ECU 22 determines whether the manipulation input to the door handle 3 is stopped (step 502). If the manipulation input is stopped (step 502: YES), the door ECU 22 resets the high-speed flag (step 503).

If it is determined, in step 502, that the manipulation input has not been stopped, that is, if the manipulation input is continuing (step 502: NO), the door ECU 22 does not execute the process of step 503. In step 501, if the high-speed flag is not set (step 501: NO), the door ECU 22 does not execute the processes of step 502 and step 503.

The door ECU 22 executes the processes of step 501 to step 503 as a subroutine of the manipulation input detecting procedure (see FIG. 2, step 101). That is, if it is determined, in step 502, that the manipulation input to the door handle 3 is continuing (step 502: NO), the high-speed flag is kept set to maintain the high-speed operation mode. If the high-speed flag is reset in step 503, the drive mode is switched from the high-speed operation mode to the normal mode in the currently executed closing operation control or opening operation control.

Operation of the door control device according to the present embodiment configured as described above will now be described.

As shown in FIG. 9, upon detection of the manipulation input to the door handle 3, the opening/closing control of the sliding door 1 is started in the normal mode. The duration t of the manipulation input is measured and if it is determined that the duration t has been continuing over the predetermined time period t0, the drive mode is switched to the high-speed operation mode, and the operation speed of the sliding door 1 is increased.

Subsequently, until the manipulation input to the door handle 3 is stopped, that is, until the user lets go of the door handle 3, the drive mode is maintained in the high-speed operation mode (point in time t1). After the manipulation input is stopped, the drive mode is restored to the normal mode, and the operation speed of the sliding door 1 is decelerated.

According to the present embodiment, opening/closing operation of the sliding door 1 is accelerated only during the time period when the user continues manipulating the door handle 3. As a result, the sliding door 1 is opened or closed at an appropriate speed that the user desires. Furthermore, a high level of safety is also ensured.

Each of the illustrated embodiments may be modified as follows.

In each of the embodiments, the present invention is embodied in the door control device 30, which opens and closes the sliding door 1 provided on the side surface of the vehicle body. However, the present invention may be applied to a control device for other doors such as a swing door, or a back door or a luggage door provided at the vehicle rear portion. The present invention may also be applied to an opening/closing body control device for a vehicle intended for an opening/closing body other than doors such as a sunroof unit and a power window unit.

In each of the above embodiments, the present invention is applied to the door handle 3 provided on the outer panel 2, which is the outer surface of the sliding door 1, that is, an outside handle. However, the present invention may be applied to a handle unit provided in a passenger compartment, that is, an inside handle.

In each of the above embodiments, the door handle 3 is provided with the contact-type manipulation detecting switch 23, which outputs the manipulation input signal Sc based on motion of the movable member, which is the handgrip 10. The door ECU 22 measures the duration t of the manipulation input to the door handle 3 based on the manipulation input signal Sc.

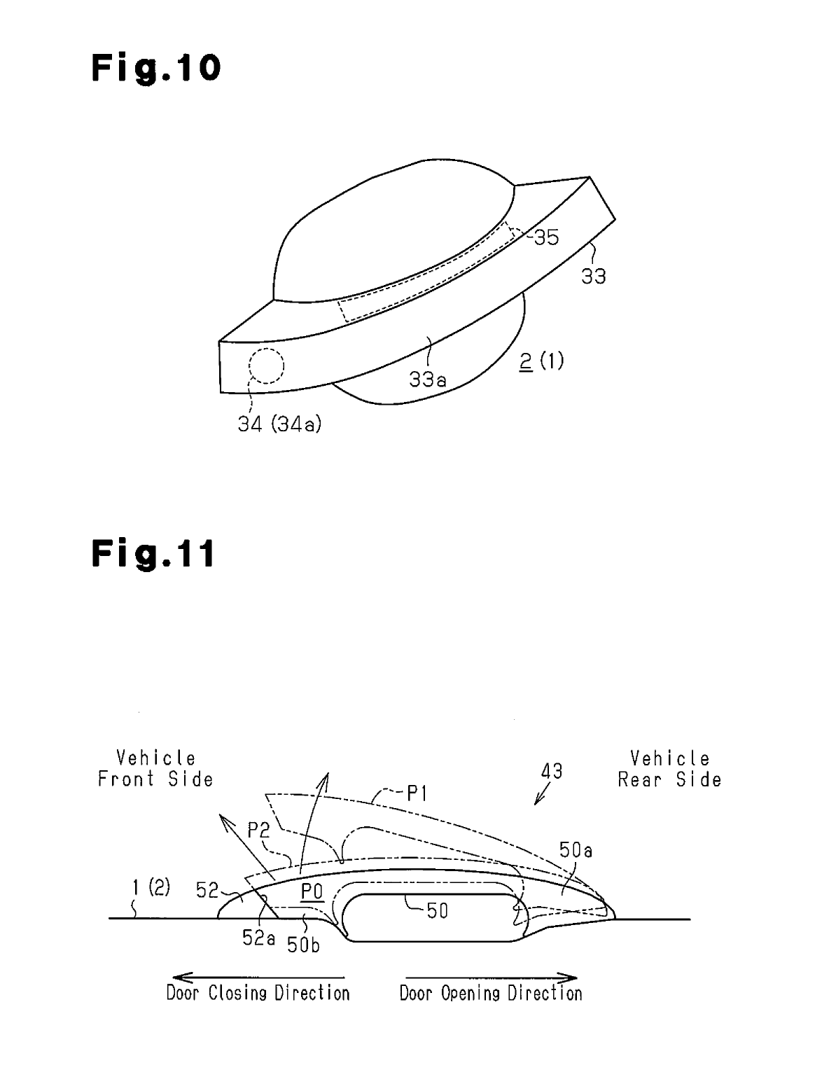

However, for example, as shown in FIG. 10, a push switch 34 or a contact switch 35, which function as a manipulation input section and a manipulation input detector, may be provided on an ornamental surface 33a of the door handle 3. The duration t of the manipulation input may be measured based on the manipulation input signal Sc output from the switches 34, 35. As the push switch 34, a known push switch may be used that is switched to an on state when a push button 34a is pushed and returned to an off state when the push button 34a is let go. As for the contact switch 35, a known capacitive sensor may be used. The time period during which the push switch 34 keeps being pushed, or the time period during which the contact switch 35 keeps being touched is measured as the duration of the manipulation input.

The “prolonged manipulation” on the above-described switches 34, 35 is also easy to continue like the “prolonged manipulation” on the handgrip 10, and is easy to intuitively understand that the prolonged manipulation will switch the operation speed of the sliding door 1. Employing such a configuration will also provide the same advantages as the above-described embodiments. Additionally, the switches 34, 35 are advantageous in that the switches 34, 35 are mounted with a simple configuration. Furthermore, manipulation input to the switches 34, 35 is easily performed during a series of manipulation process using the door handle 3.

In the example shown in FIG. 10, the switches 34, 35 are provided on the ornamental surface 33a of the door handle 33, but may be provided at any position such as an outer panel 2, which forms the ornamental surface of the sliding door 1, or in a passenger compartment.

Furthermore, the push switch 34 and the contact switch 35 may be independently applied. Alternatively, the push switch 34, the contact switch 35, and the manipulation detecting switch 23, which corresponds to the motion of the handgrip 10, may be selected as appropriate and combined as required.

In each of the above embodiments, the door handle 3 including the handgrip 10, which moves such that the distal end (the end close to the vehicle front side) is pulled, is used as the handle unit, which functions as the manipulation input section. However, for example, the present invention may be embodied in the configuration that uses a handle unit that is operable by manipulation inputs in two directions as a door handle 43 shown in FIG. 11.

That is, the door handle 43 includes a handgrip 50, which moves in two directions including the direction toward the vehicle rear side (right side in FIG. 11) and the vehicle front side (left side in FIG. 11) in accordance with the manipulation inputs. Specifically, when manipulated toward the vehicle rear side, the handgrip 50 is moved such that a distal end 50b is pivoted toward the vehicle rear side with a rear end 50a serving as a fulcrum, and is thus placed at a first motion position P1. Furthermore, when manipulated toward the vehicle front side, the handgrip 50 is moved toward the vehicle front side such that the distal end 50b slides along an inclined surface 52a of a handle cap 52, which abuts against the distal end 50b, and is thus placed at a second motion position P2. The door handle 43 is configured such that, when the manipulation input to the door handle 43 is stopped, that is, when a user lets go of the handgrip 50, the handgrip 50 restores to a neutral position P0 shown with the solid line by a non-illustrated urging member.

By using such a handle unit, the restraint of the sliding door 1 by the lock mechanisms is released by intuitively manipulating the door handle 3 in the direction that matches the direction in which the sliding door 1 should be operated, not only when the sliding door 1 is opened from the fully closed position, but also when the sliding door 1 is closed from the fully open position. Furthermore, the sliding door 1 is opened or closed in a direction corresponding to the direction of the manipulation input to the door handle 3. The operability and convenience are further improved by switching the operation speed of the sliding door 1 in accordance with the duration of the manipulation input.

In each of the above embodiments, the process for detecting a manipulation input to the door handle 3 (see FIG. 2, step 101) is executed prior to the process for detecting the operation position of the sliding door 1 (step 102), but the execution order may be reversed.

In each of the above embodiments, the deceleration zones α1, α2 are set in the vicinity of the fully open position and the fully closed position of the sliding door 1. However, the deceleration zone may be set only in the vicinity of one of the fully open position and the fully closed position.

In each of the above embodiments, the user is notified of the currently executed drive mode by a sound during opening/closing operation of the sliding door 1 by outputting a pulse sound the time interval of which changes in accordance with the operation speed of the sliding door 1. However, the volume or the pitch of the notification sound may be changed in accordance with the operation speed of the sliding door 1. Besides the sound, for example, the user may be notified of the currently executed drive mode by light (time intervals of flashing light or the color of the light). The configuration that does not notify the user of the currently executed drive mode may also be employed.

In the above described embodiment, the door ECU 22 includes the normal mode and the high-speed operation mode as the drive modes. However, three or more drive modes may be provided.

In this case, switching manner of the drive modes may be set in various ways. That is, any configuration may be employed for “switching the drive mode to the high-speed operation mode” as long as the drive mode is switched to another drive mode with the operation speed of the sliding door 1 greater than the current drive mode regardless of which drive mode is selected before the duration t of the manipulation input to the door handle 3 exceeds the predetermined time period t0.

In each of the above embodiments, if the drive mode is the high-speed operation mode when the sliding door 1 enters the deceleration zones α1, α2, the drive mode is restored to the normal mode. However, the drive mode after switching does not necessarily have to be the normal mode as long as a drive mode is selected that has a slower operation speed of the sliding door 1 than the high-speed operation mode. Similarly, as for a case in which the drive mode is switched when the sliding door 1 is stopped, or when the manipulation input is stopped (the second embodiment), the drive mode selected after switching does not necessarily have to be the normal mode as long as a drive mode with a slower operation speed than the high-speed operation mode before switching is selected. In these cases, as “the drive mode with a slower operation speed than the high-speed operation mode”, different drive modes may be selected in accordance with the situation in which the drive mode is switched from the high-speed operation mode.

The drive mode may be switched to a drive mode with a greater operation speed of the sliding door 1 in accordance with the length of the duration of the manipulation input. In this case, two or more drive modes are provided as the high-speed operation mode. With this configuration, the longer the manipulation input continues, the greater the operation speed will be. As a result, the sliding door 1 is opened or closed more appropriately at a speed that the user desires.

The processes for switching the drive modes “when the sliding door is stopped (see FIG. 4)”, “when entering the sliding door deceleration zones (see FIG. 6)”, and “when manipulation input is stopped (see FIG. 8)” shown in the above embodiments may be executed independently, or selected as appropriate and combined as required to be executed. For example, as in the second embodiment, when the drive mode is switched from the high-speed operation mode to the normal mode since the manipulation input is stopped, the process for switching the drive mode to the normal mode when entering the deceleration zone does not need to be performed. Also, the configuration that does not execute the process for switching from the high-speed operation mode to the normal mode is not excluded. Furthermore, for example, the manner of the process for switching to the normal mode, or the manner of the process for determining reset of the high-speed flag may be changed as required.

1.-13. (canceled)

14. An opening/closing body control device for a vehicle, comprising:
a drive section that drives an opening/closing body of the vehicle;
a manipulation input section manipulated to open and close the opening/closing body;
a manipulation input detector that detects a manipulation input to the manipulation input section;
a controller that controls the drive section based on detection of the manipulation input;
a measuring section that measures a duration of the manipulation input; and
an operation position detector that detects the operation position of the opening/closing body, wherein
the controller is configured to be capable of controlling the drive section in a drive mode selected from a plurality of drive modes which have different operation speeds of the opening/closing body,
the controller is configured such that, when the duration exceeds a predetermined time period, the controller switches the drive mode to a high-speed operation mode the operation speed of which is greater than the drive mode selected before the duration exceeds the predetermined time period, and
the controller is configured to set a deceleration zone corresponding to at least one of a fully open position and a fully closed position of the opening/closing body, and the controller is configured such that, when the drive mode at the time when the opening/closing body enters the deceleration zone is the high-speed operation mode, the controller switches the drive mode to a drive mode the operation speed of which is slower than the high-speed operation mode.

15. The opening/closing body control device for a vehicle according to claim 14, wherein the controller is configured such that, when the manipulation input is stopped after switching the drive mode to the high-speed operation mode, the controller switches the drive mode to a drive mode the operation speed of which is slower than the high-speed operation mode.

16. The opening/closing body control device for a vehicle according to claim 14, wherein the controller is configured such that, even when the manipulation input is stopped after switching the drive mode to the high-speed operation mode, the controller maintains the high-speed operation mode.

17. The opening/closing body control device for a vehicle according to claim 14, wherein the controller is configured such that, when the drive mode at the time when the opening/closing body is stopped is the high-speed operation mode, the controller switches the drive mode to a drive mode the operation speed of which is slower than the high-speed operation mode.

18. An opening/closing body control device for a vehicle, comprising:
a drive section that drives an opening/closing body of the vehicle;
a manipulation input section manipulated to open and close the opening/closing body;
a manipulation input detector that detects a manipulation input to the manipulation input section;
a controller that controls the drive section based on detection of the manipulation input; and
a measuring section that measures a duration of the manipulation input, wherein
the controller is configured to be capable of controlling the drive section in a drive mode selected from a plurality of drive modes each of which has an operation speed of the opening/closing body set to a different speed,
the controller is configured such that, when the duration exceeds a predetermined time period, the controller switches the drive mode to a high-speed operation mode the operation speed of which is greater than the drive mode selected before the duration exceeds the predetermined time period, and
the controller is configured such that, when the drive mode at the time when the opening/closing body is stopped is the high-speed operation mode, the controller switches the drive mode to a drive mode the operation speed of which is slower than the high-speed operation mode.

19. The opening/closing body control device for a vehicle according to claim 14, wherein
the manipulation input section includes a handle unit that is provided on the opening/closing body and has a movable member, and
the manipulation input detector detects manipulation of the movable member as the manipulation input.

20. The opening/closing body control device for a vehicle according to claim 19, wherein the handle unit is configured to be operable by a manipulation input in an opening direction corresponding to an opening operation of the opening/closing body and operable by a manipulation input in a closing direction corresponding to a closing operation of the opening/closing body.

21. The opening/closing body control device for a vehicle according to claim 14, wherein
the manipulation input section includes a push switch, and
the manipulation input detector detects pushing of the push button as the manipulation input.

22. The opening/closing body control device for a vehicle according to claim 14, wherein
the manipulation input section includes a contact switch, and
the manipulation input detector detects a fact that the contact switch is brought into contact as the manipulation input.

23. The opening/closing body control device for a vehicle according to claim 21, wherein the switch is provided on an ornamental surface of the handle unit provided on the opening/closing body.

24. The opening/closing body control device for a vehicle according to claim 21, wherein the switch is provided on an ornamental surface of the opening/closing body.

25. The opening/closing body control device for a vehicle according to claim 14, wherein the controller includes a notification section for notifying a user of the currently executed drive mode.

26. The opening/closing body control device for a vehicle according to claim 14, wherein the controller is configured to accelerate the operation speed of the opening/closing body as the duration of the manipulation input is increased.

27. The opening/closing body control device for a vehicle according to claim 18, wherein
the manipulation input section includes a handle unit that is provided on the opening/closing body and has a movable member, and
the manipulation input detector detects manipulation of the movable member as the manipulation input.

28. The opening/closing body control device for a vehicle according to claim 27, wherein the handle unit is configured to be operable by a manipulation input in an opening direction corresponding to an opening operation of the opening/closing body and operable by a manipulation input in a closing direction corresponding to a closing operation of the opening/closing body.

29. The opening/closing body control device for a vehicle according to claim 18, wherein
the manipulation input section includes a push switch, and
the manipulation input detector detects pushing of the push button as the manipulation input.

30. The opening/closing body control device for a vehicle according to claim 18, wherein
the manipulation input section includes a contact switch, and
the manipulation input detector detects a fact that the contact switch is brought into contact as the manipulation input.

31. The opening/closing body control device for a vehicle according to claim 29, wherein the switch is provided on an ornamental surface of the handle unit provided on the opening/closing body.

32. The opening/closing body control device for a vehicle according to claim 18, wherein the controller includes a notification section for notifying a user of the currently executed drive mode.

33. The opening/closing body control device for a vehicle according to claim 18, wherein the controller is configured to accelerate the operation speed of the opening/closing body as the duration of the manipulation input is increased.
